(19) United States
(12) Patent Application Publication
(10) Pub. No.: US 2023/0156318 A1
(43) Pub. Date: May 18, 2023

(54) IMAGING APPARATUS AND PROGRAM

(71) Applicant: FUJIFILM Corporation, Tokyo (JP)

(72) Inventors: Shigeru KONDO, Saitama-shi (JP); Michio CHO, Saitama-shi (JP); Shoki KASAHARA, Saitama-shi (JP)

(73) Assignee: FUJIFILM Corporation, Tokyo (JP)

(21) Appl. No.: 18/155,596

(22) Filed: Jan. 17, 2023

Related U.S. Application Data
(63) Continuation of application No. PCT/JP21/07727, filed on Mar. 1, 2021.

(30) Foreign Application Priority Data
Jul. 22, 2022 (JP) 2020-125376

(51) Int. Cl. H04N 23/63; H04N 23/667

(52) U.S. Cl. CPC H04N 23/633; H04N 23/667

(57) ABSTRACT

An imaging apparatus that can display information to be checked by a user at an easily viewed position on a display device of an observation unit is provided.

An imaging apparatus according to one embodiment of the present invention includes an imaging element, an observation unit including a display device and an observation optical system, and a processor configured to display a captured image based on an imaging signal read out from the imaging element and related information related to generation of the captured image, on the display device. The processor is configured to display the related information at a first display position and a second display position on the display device during imaging performed by the imaging element. The second display position is present on an inner side of the display device than the first display position. Types of the related information to be displayed at the second display position are set in advance before imaging. The processor is configured to switch between display and non-display of the related information at the second display position based on a specific operation of a user during imaging.

### CROSS-REFERENCE TO RELATED APPLICATIONS

This application is a Continuation of PCT International Application No. PCT/JP2021/007727 filed on Mar. 1, 2021, which claims priority under 35 U.S.C. § 119(a) to Japanese Patent Application No. 2020-125376 filed on Jul. 22, 2020. The above applications are hereby expressly incorporated by reference, in their entirety, into the present application.

### BACKGROUND OF THE INVENTION

### 1. Field of the Invention

One embodiment of the present invention relates to an imaging apparatus and a program and particularly, to an imaging apparatus comprising an observation unit including a display device and an observation optical system and a program used in an imaging apparatus.

### 2. Description of the Related Art

In an imaging apparatus such as a digital camera, various types of information including a shutter speed, an F number, imaging sensitivity, and the like can be displayed on a display. The various types of information are displayed together with a captured image (specifically, a live view image or the like) during imaging, and a user can check an imaging condition and the like together with the captured image during imaging.

In addition, in an imaging apparatus comprising an observation unit such as an electronic view finder (EVF), the captured image and the various types of information may be displayed on a display device of the observation unit. In the related art, information related to the imaging condition and the like is displayed on an outer side of the captured image or displayed in a superimposed manner on an outer edge portion of the captured image on the display device of the observation unit (for example, refer to WO2010/029767A and JP2018-125801A).

### SUMMARY OF THE INVENTION

An object of one embodiment of the present invention is to solve the above problem in the technology of the related art and provide an imaging apparatus that can display information to be checked by a user at an easily viewed position on a display device of an observation unit.

In addition, an object of one embodiment of the present invention is to provide a program used in the imaging apparatus.

In order to accomplish the above object, an imaging apparatus according to one embodiment of the present invention comprises an imaging element, an observation unit including a display device and an observation optical system, and a processor configured to display a captured image based on an imaging signal read out from the imaging element and related information related to generation of the captured image, on the display device, in which the processor is configured to display the related information at a first display position and a second display position on the display device during imaging performed by the imaging element, the second display position is present on an inner side of the display device than the first display position, types of the related information to be displayed at the second display position are set in advance before imaging, and the processor is configured to switch between display and non-display of the related information at the second display position based on a specific operation of a user during imaging.

In addition, the second display position may be a position overlapping with the captured image.

In addition, a horizontal viewing angle of the display device in a longitudinal direction of the imaging element may be greater than or equal to 33 degrees.

In addition, the related information to be displayed at the second display position may be selectable by the user, and the processor may be configured to, in a case where a plurality of pieces of the related information to be displayed at the second display position are selected, display the selected plurality of pieces of the related information together on the display device.

In addition, the related information to be displayed at the second display position may include at least one of information related to an imaging condition of the imaging element or information related to a correction condition of the imaging signal.

In addition, the related information to be displayed at the second display position may include at least one of a shutter speed, sensitivity of the imaging element, or an F number of an imaging lens at a time of capturing.

In addition, the processor may be configured to change at least one of the second display position or a display aspect of the related information to be displayed at the second display position in accordance with a setting of the user.

In addition, the processor may be configured to change at least one of the second display position or a display aspect of the related information to be displayed at the second display position in accordance with a color or a design of each region of the captured image.

In addition, the processor may be configured to, in a case where the specific operation is performed or in a case where the specific operation is not performed during imaging, display the related information at the second display position.

In addition, the processor may be configured to, in a case where the specific operation is performed during imaging, switch display of the related information at the second display position to non-display, after an elapsed time from when the specific operation is performed reaches a setting time.

In addition, the imaging apparatus according to one embodiment of the present invention may further comprise a release button pushed by the user, in which the release button is pushable in two steps by the user, and the specific operation is an operation of pushing the release button to a position of a first step.

In addition, a mode in which the related information is displayed at the second display position may include a first mode in which the related information is displayed at the second display position in a case where the specific operation is performed during imaging, and a second mode in which the related information is displayed at the second display position in a case where the specific operation is not performed during imaging, and the processor may be configured to select one of the first mode and the second mode based on an instruction input of the user.

In addition, the imaging apparatus according to one embodiment of the present invention may further comprise a sensor that outputs a signal corresponding to a distance from the user to the observation unit, in which the processor is configured to change at least one of the second display position or a display aspect of the related information to be displayed at the second display position based on the signal output from the sensor.

In addition, the display device may have a display region in which an image is displayed, and in a case where a distance from a center of the display region to an end of the display region in a longitudinal direction of the imaging element is 1, the second display position may be a position at which a distance from the end of the display region is greater than or equal to 0.15 and less than or equal to 1.0.

In addition, the second display position may be a position at which a viewing angle of the display device is within 25 degrees.

In addition, the processor may be configured to switch a display position of the related information from one of the first display position and the second display position to the other based on the specific operation.

In addition, the processor may be configured to record data of the captured image to which data of the related information is added on a recording medium based on a recording instruction of the captured image provided by the user.

In addition, in order to accomplish the above object, a program according to one embodiment of the present invention is a program used in an imaging apparatus including an imaging element and an observation unit including a display device and an observation optical system, in which a captured image based on an imaging signal read out from the imaging element and related information related to generation of the captured image are displayed on the display device, the related information is displayed at a first display position and a second display position on the display device during imaging performed by the imaging element, the second display position is present on an inner side of the display device than the first display position, types of the related information to be displayed at the second display position are set in advance before imaging, and display or non-display of the related information at the second display position is switched based on a specific operation of a user during imaging.

### BRIEF DESCRIPTION OF THE DRAWINGS

FIG. 1 is a diagram illustrating an exterior of an imaging apparatus according to an embodiment of the present invention.

FIG. 2 is a diagram illustrating a configuration of the imaging apparatus according to the embodiment of the present invention.

FIG. 3A is a description diagram of a first display position and a second display position and illustrates a case of a normal display mode.

FIG. 3B is a description diagram of the first display position and the second display position and illustrates a case of a full-size display mode.

FIG. 4 is a description diagram of a method of measuring a viewing angle of a display device.

FIG. 5 is a diagram illustrating an example of display content of the display device during imaging.

FIG. 6 is a diagram illustrating an example related to a transition of the display content of the display device during imaging.

FIG. 7 is a diagram illustrating the display content of the display device before a specific operation is performed in a first mode.

FIG. 8 is a diagram illustrating the display content of the display device immediately after the specific operation is performed in a second mode.

FIG. 9 is a diagram illustrating an example of a position setting screen.

FIG. 10 is a diagram illustrating a screen example in which the second display position is changed in accordance with a color and the like of a captured image.

FIG. 11 is a diagram illustrating an example of a display aspect setting screen.

FIG. 12 is an enlarged diagram of a location in which a display aspect of related information is changed in accordance with a design of the captured image.

FIG. 13 is a diagram illustrating steps S001 to S011 in processing related to display on the display device during imaging.

FIG. 14 is a diagram illustrating steps S021 to S030 in the processing related to the display on the display device during imaging.

### DESCRIPTION OF THE PREFERRED EMBODIMENTS

Hereinafter, one preferred embodiment (hereinafter, referred to as the present embodiment) of the present invention will be described in detail with reference to the appended drawings. It should be noted that the embodiment described below is merely an example for facilitating understanding of the present invention and does not limit the present invention. That is, the present invention may be subjected to changes or improvements from the embodiment described below without departing from the gist thereof. In addition, the present invention includes equivalents thereof.

In addition, in describing a position, a direction, a state, and the like of each part of an imaging apparatus (hereinafter, referred to as an imaging apparatus 10) according to the present embodiment, the description will be provided on an assumption that the imaging apparatus 10 is used in a normal posture, unless otherwise specified. The “normal posture” means a posture of the imaging apparatus 10 in a case where an up-to-down direction of the imaging apparatus 10 is along a vertical direction and a side-to-side direction (that is, a longitudinal direction of an imaging element 20 described later) of the imaging apparatus 10 is along a horizontal direction. In a case where the imaging element 20 has a square shape, any one of the side-to-side direction and a top-to-bottom direction of the imaging apparatus 10 is the longitudinal direction of the imaging element 20.

[Basic Configuration of Imaging Apparatus]

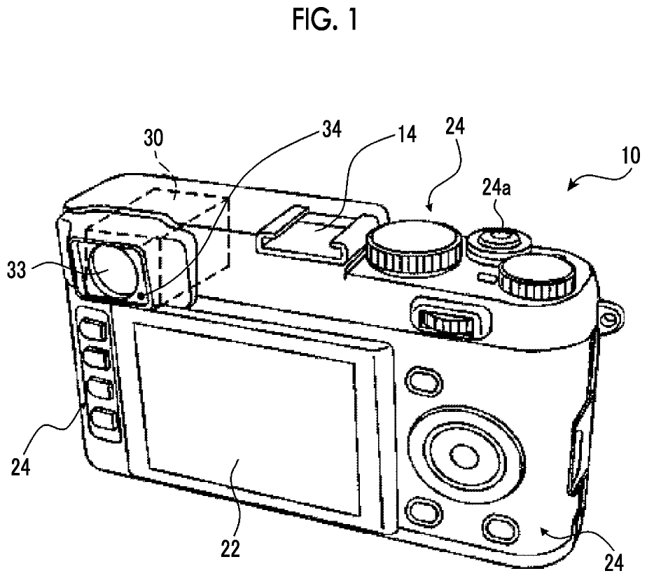

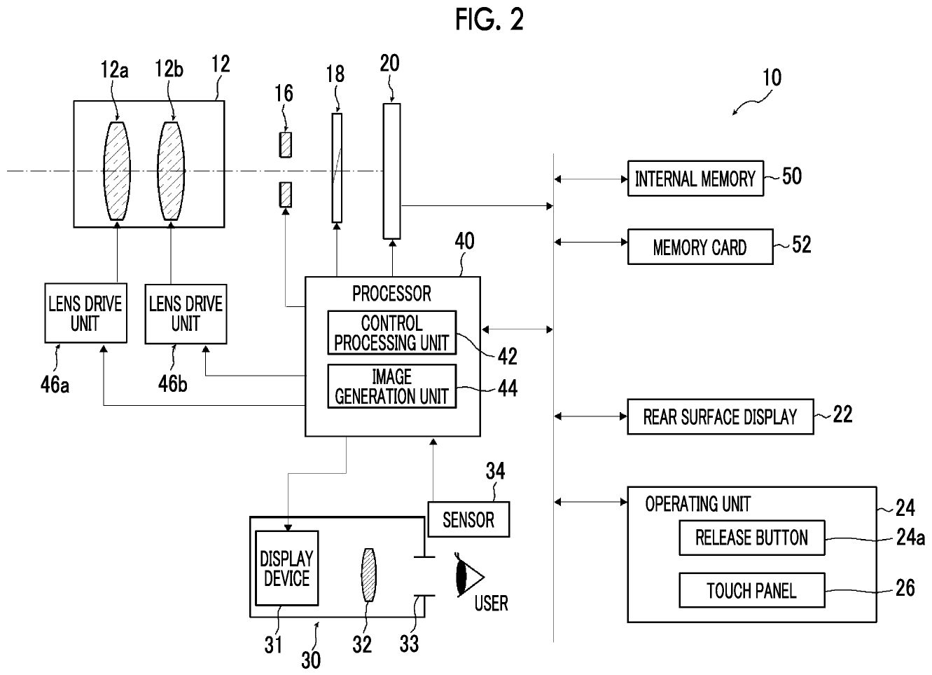

The imaging apparatus 10 is, for example, a digital camera and comprises an imaging lens 12, a stop 16, a shutter 18, the imaging element 20, a rear surface display 22, an operating unit 24, an observation unit 30, a processor 40, an internal memory 50, and the like as illustrated in FIGS. 1 and 2. The imaging apparatus 10 may be of a lens-integrated type or a lens-interchangeable type.

The imaging lens 12 includes a zoom lens 12a and a focus lens 12b, and each lens can be moved in an optical axis direction by lens drive units 46a and 46b. Zooming is performed by the movement of the zoom lens 12a, and an auto focus (AF) operation is performed by the movement of the focus lens 12b.

The stop 16 is subjected to a drive control by the processor 40 and adjusts light (imaging light) incident on the imaging element 20. The shutter 18 is arranged between the stop 16 and the imaging element 20 and is subjected to an opening and closing control by the processor 40. In the present embodiment, a mechanical shutter based on the shutter 18 and an electronic shutter based on the imaging element 20 are used together, and a shutter system can be switched by a user operation.

The imaging element 20 is an image sensor of a color imaging system including color filters of three colors of red, green, and blue (RGB) and is composed of a charged coupled device (CCD), a complementary metal oxide semiconductor (CMOS), or the like.

In the following description, imaging means imaging performed by the imaging element 20.

The rear surface display 22 is provided on a rear surface of the imaging apparatus 10 and displays a captured image of the imaging element 20 and various types of information. For example, during imaging, a live view image is displayed on the rear surface display 22 as the captured image. The live view image is a real-time image (live view video) during imaging.

The operating unit 24 includes a plurality of buttons provided on an outer surface of a housing of the imaging apparatus 10 and receives an operation of a user (capturing person) of the imaging apparatus 10. In setting or changing various items related to imaging, the user performs a corresponding operation through the operating unit 24. In addition, a touch panel 26 may be provided on the rear surface display 22 as one operating unit 24.

The operating unit 24 includes a release button 24a illustrated in FIGS. 1 and 2. For example, the release button 24a is composed of a push button of a two-step stroke type and can be pushed in two steps by the user. An operation of pushing the release button 24a in two steps corresponds to a recording instruction of the captured image. That is, in providing the recording instruction of the captured image, the user first pushes the release button 24a to a position of a first step (half push position). Accordingly, automatic exposure (AE) and auto focus (AF) are locked. Then, in a case where the release button 24a is pushed to a position of a second step (full push position) by the user, recording of the captured image is performed.

The observation unit 30 is a finder at which the user looks in order to check an angle of view, a focus state, and the like during imaging, and is specifically an electronic view finder (EVF). The observation unit 30 may be a hybrid finder that can be switched between a mode of an optical view finder (OVF) and a mode of the EVF. In addition, the observation unit 30 may be a finder incorporated in the imaging apparatus 10 or may be a finder of an external type that is attachably and detachably connected to a connecting unit 14 (that is, a hot shoe) provided in an upper portion of the imaging apparatus 10.

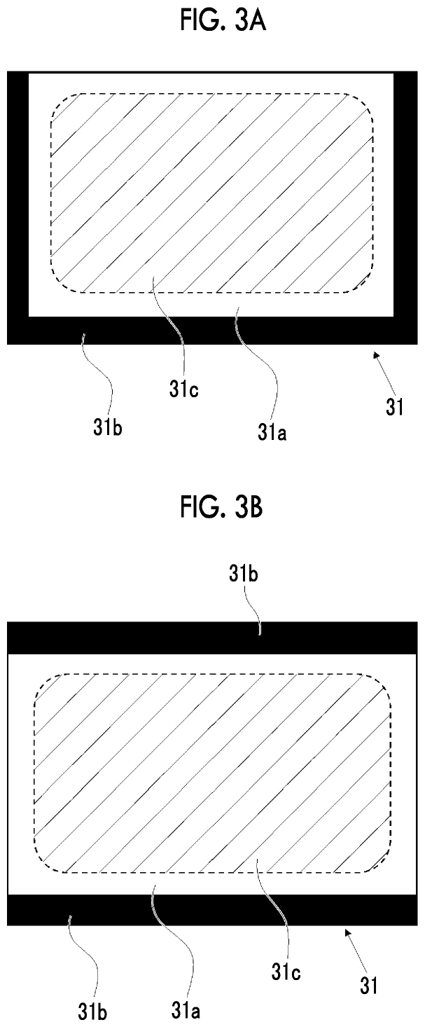

The observation unit 30 includes a display device 31 and an observation optical system 32 as illustrated in FIG. 2. The display device 31 is arranged inside the imaging apparatus 10 and is composed of, for example, a liquid crystal display (LCD), a plasma display panel (PDP), an organic electroluminescence (EL) display, a light emitting diode (LED) display, or an electronic paper. The display device 31 has a display region 31a illustrated in FIGS. 3A and 3B and displays an image in the display region 31a. A size of the display region 31a is switched in accordance with a display mode. In a normal display mode at a normal time, the size in FIG. 3A is used. In a full-size display mode in which the image is displayed in the maximum size, the size in FIG. 3B is used.

The observation optical system 32 consists of a lens, a prism, and the like and is arranged between the display device 31 and eyes of the user in order to enlarge the image and the like displayed on the display device 31. Arranging between the display device 31 and the eyes of the user means arranging at a position in the middle of an optical path of light heading toward the eyes of the user from the display device 31. In FIG. 2, while one lens is illustrated as the observation optical system 32, the observation optical system 32 may be composed of a plurality of lenses and the like.

The user can view the image and the like displayed on the display device 31 through the observation optical system 32 by looking at inside the observation unit 30 from an eyepiece window 33 provided on the rear surface of the imaging apparatus 10 during imaging.

In addition, a sensor 34 for distance measurement illustrated in FIGS. 1 and 2 is installed in a predetermined location in the eyepiece window 33 or near the eyepiece window 33. The sensor 34 outputs a signal corresponding to a distance from the user to the observation unit 30 (strictly, the eyepiece window 33). An infrared sensor, a time of flight (TOF) camera, or the like can be used as the sensor 34.

In the observation unit 30 of the present embodiment, the display device 31 of a large screen having a wide width is used for the purpose of increasing a sense of immersion (an impression that feels like being present within the angle of view) that the user feels in viewing the live view image and a reproduced image on the display device 31. Specifically, a viewing angle of a virtual image of the display device 31 in the longitudinal direction of the imaging element 20, that is, a horizontal viewing angle in the horizontal direction, is set to be greater than or equal to 33 degrees. The horizontal viewing angle of the display device 31 is preferably greater than or equal to 35 degrees and more preferably greater than or equal to 38 degrees. An upper limit of the horizontal viewing angle is preferably less than or equal to 45 degrees.

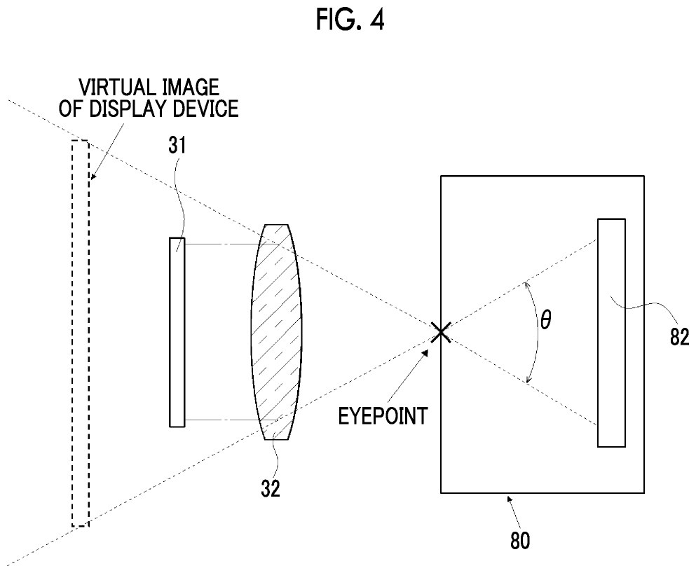

The horizontal viewing angle of the display device 31 is a viewing angle (viewing cone) that spreads in a cone shape in a case where the user views the display device 31 (strictly, the virtual image of the display device 31 enlarged by the observation optical system 32) by looking at the observation unit 30. Here, the horizontal viewing angle is an angle in the horizontal direction based on a visual line of the user as a reference (0 degrees). For example, the horizontal viewing angle of the display device 31 can be measured using the method illustrated in FIG. 4.

First, the processor 40 displays a sample image (for example, a white image) on the display device 31, and a measurement camera 80 is arranged at a position ahead of the eyepiece window 33. The measurement camera 80 is a digital camera including an imaging lens and an imaging element 82, and settings of an imaging size of the imaging element 82 and a focal length of the imaging lens are settings with which the entire virtual image of the display device 31 can be sufficiently captured. The measurement camera 80 is positioned such that an incidence pupil of the imaging lens of the measurement camera 80 is arranged at a position set as an eyepoint of the observation unit 30. Then, the sample image displayed on the display device 31 is captured by the imaging element 82 of the measurement camera 80, and a range in which the sample image is captured in an imaging angle of view is obtained. Specifically, a position of a pixel on which light emitted from both ends of the display device 31 in a side-to-side width direction in the imaging element 82 is incident is specified, and the range (in FIG. 4, the range denoted by a symbol θ) in which the sample image is captured is obtained from the specified position of the pixel. The horizontal viewing angle of the display device 31 is derived from the obtained range of the sample image.

The above method is an example of a method of measuring the viewing angle of the display device 31. The viewing angle of the display device 31 may be measured using a measurement method to which the above measurement method is applied, or other measurement methods based on the same principle or a different principle from the above measurement method. In addition, the viewing angle may be measured using a well-known viewing angle measurement device.

The processor 40 controls each unit of the imaging apparatus 10 and executes various types of processing including imaging, recording of the captured image, and display of the captured image and the like. The processor 40 may be composed of one or a plurality of hardware devices, for example, a central processing unit (CPU), a field programmable gate array (FPGA), a digital signal processor (DSP), an application specific integrated circuit (ASIC), a graphics processing unit (GPU), or other integrated circuits (ICs). Alternatively, the processor 40 may be composed of a combination thereof. In addition, in the processor 40, as represented by a system on chip (SoC) or the like, functions of the entire processor 40 may be configured in one integrated circuit (IC) chip. The above hardware configuration of the processor 40 may be implemented by an electric circuit (circuitry) in which circuit elements such as semiconductor elements are combined.

The internal memory 50 is an example of a recording medium. The internal memory 50 stores a program executed by the processor and various types of data. By executing the program stored in the internal memory 50 by the processor 40, the processor 40 functions as a control processing unit 42 and an image generation unit 44 as illustrated in FIG. 2.

The program is not necessarily limited to a case of being stored in the internal memory 50 and may be stored in a memory card 52 that is an example of the recording medium. The memory card 52 is used by inserting the memory card 52 into a card slot, not illustrated, provided in the imaging apparatus 10. In addition, in a case where the observation unit 30 is a finder of an external type, a program related to a control of the observation unit 30 including the display of the image and the like on the display device 31 may be recorded in a memory (not illustrated) provided on a finder side.

The control processing unit 42 controls each unit of the imaging apparatus 10 in accordance with an operation of the user performed through the operating unit 24 or with a predetermined control program. For example, the control processing unit 42 controls the stop 16, the shutter 18, and the imaging element 20 in accordance with an imaging mode selected by the user.

In addition, the control processing unit 42 displays the captured image (specifically, the live view image) on the rear surface display 22 by controlling the rear surface display 22 during imaging. In addition, during imaging, the control processing unit 42 determines whether or not the distance from the user to the observation unit 30 is less than a predetermined distance (specifically, a first distance described later), that is, whether or not the eyes of the user are brought close to the eyepiece window 33, based on the signal output from the sensor 34. In a case where the distance is less than the predetermined distance, the control processing unit 42 automatically displays the captured image on the display device 31 of the observation unit 30. However, the present invention is not limited thereto. The control processing unit 42 may display the captured image on the display device 31 at a timing at which the user operates a display switch included in the operating unit 24.

The image generation unit 44 generates the captured image based on an imaging signal read out from the imaging element 20 during imaging. Specifically, the image generation unit 44 generates an image signal by performing analog/digital (A/D) conversion on the imaging signal and executing image correction processing such as gamma correction and white balance correction on the digital signal after conversion. The image signal is compressed into compressed digital image data (hereinafter, simply referred to as image data) in accordance with a predetermined standard.

In addition, the image generation unit 44 can generate image data of an image in which colors are reproduced with a color reproduction pattern designated by the user. The color reproduction pattern includes a color reproduction pattern similar to colors viewed by eyes, a color reproduction pattern having high chroma saturation, a color reproduction pattern having a monochrome tone, and the like. In addition, for example, in a case where an electronic camera shake correction function is ON, the image generation unit 44 extracts an image having a slightly smaller angle of view than a full size from the captured image having the full size and changes an extraction range in accordance with a shake amount (displacement amount) of the imaging apparatus 10.

During imaging, the image indicated by the image data generated by the image generation unit 44, that is, the captured image, is displayed on the rear surface display 22 and the display device 31 of the observation unit 30 as the live view image under control of the control processing unit 42.

In addition, during imaging, in a case where the release button 24a is pushed to the position of the second step, the captured image is recorded under an imaging condition and a correction condition at the point in time. The imaging condition is a control condition related to imaging and includes, for example, an exposure condition such as an F number, a shutter speed, and ISO sensitivity and a dynamic range. The correction condition is a condition for correcting a gain, a gradation, or a tone with respect to the imaging signal read out from the imaging element 20 and includes, for example, the exposure condition, white balance, and the color reproduction pattern.

Data (image data) of the captured image that is a target to be recorded is recorded on the recording medium such as the internal memory 50 of the imaging apparatus 10 or the memory card 52. At this point, the processor 40 adds data of related information to the data of the captured image that is the target to be recorded, and records the image data to which the data of the related information is added on the recording medium. The related information is information related to the generation of the captured image including the imaging condition and the correction condition. Details will be described later.

Hereinafter, an operation and processing of each of the control processing unit 42 and the image generation unit 44 will be described as an operation and processing of the processor 40 unless otherwise specified.

[Display Content on Display Device During Imaging]

Next, display content displayed on the display device 31 of the observation unit 30 by the processor 40 during imaging will be described. While the following description is provided by assuming a case where the display mode is the full-size display mode, the following content is also applied to a case where the display mode is the normal display mode.

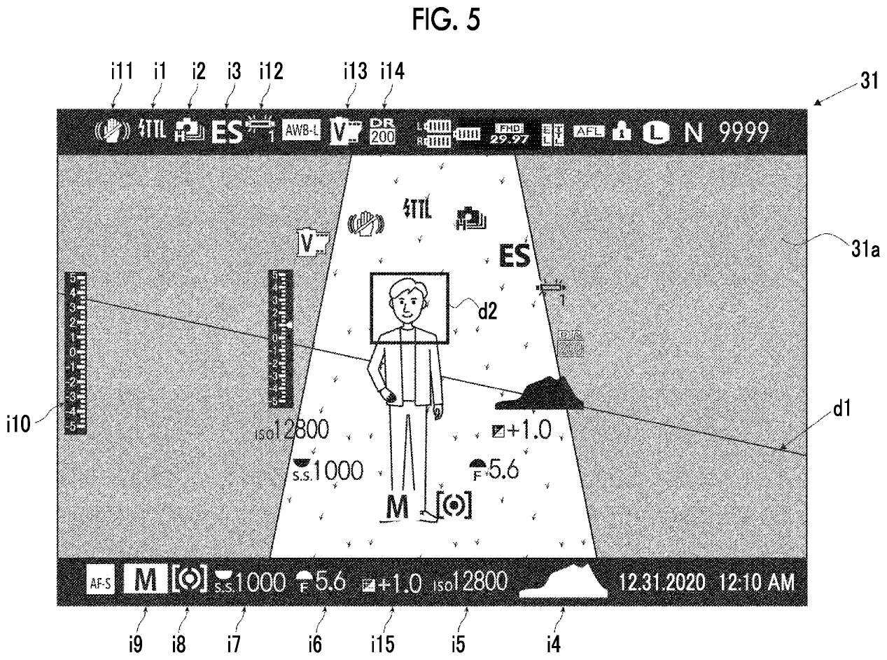

During imaging, the processor 40 displays the captured image on the display device 31 of the observation unit 30 and displays various types of the related information as illustrated in FIG. 5. The related information includes at least one of information related to the imaging condition of the imaging element 20 applied during imaging or information related to the correction condition of the imaging signal. In the present embodiment, the related information includes both thereof.

The information related to the imaging condition includes, for example, a setting mode for imaging, an imaging system, information related to the exposure condition during imaging, and a lock situation of each auto setting function including AF, AE, and the like. The setting mode for imaging includes, for example, a mode related to a flash, an imaging mode (capturing mode), a continuous shooting mode, a video mode, a photometry mode, and a focus mode. The imaging system includes, for example, a shutter system. The information related to the exposure condition includes, for example, a set value of each of the F number, the shutter speed, and the ISO sensitivity, a set value of an exposure amount, and a histogram showing a distribution of brightness within the imaging angle of view. The lock of the auto setting function includes, for example, AE lock, AR lock, and through the lens (TTL) automatic light control lock.

The information related to the correction condition includes, for example, a set value of light control correction, a set value of exposure correction, an image size, an image quality mode, ON and OFF of a camera shake correction function and the like, the white balance, the dynamic range, the color reproduction pattern, and auto white balance (AWB) lock.

The above information is an example of the related information. Related information other than the above information may be applied, or a part of the related information may not be included.

In addition, as illustrated in FIG. 5, the related information is displayed by a numerical value, a mark such as an icon, a graph, an indicator showing a current value in a scale representing a variable range, and the like.

During imaging, the processor 40 can further display information other than the related information on the display device 31. For example, the displayed information other than the related information includes a date and a time point, ON and OFF of a self timer, a remaining battery capacity, the number of capturable images, and an imaging support mark including an electronic spirit level d1 and an AF frame d2 illustrated in FIG. 5.

During imaging, the processor 40 can display the related information at first display position and second display position on the display device 31 as illustrated in FIG. 5. The first display position is a position on an outer side of the display region 31a on the display device 31. For example, in a case of the normal display mode, a position in an outer edge region 31b of a quadrangular frame shape surrounding the display region 31a on the display device 31 corresponds to the first display position (refer to FIG. 3A). In addition, in a case of the full-size display mode, a position in the outer edge region 31b of a band shape arranged in upper and lower end portions of the display device 31 and a position near an end of the display region 31a correspond to the first display position (refer to FIG. 3B).

The second display position is on an inner side of the first display position on the display device 31 and is a position overlapping with the captured image (strictly, the live view image) in the present embodiment. That is, during imaging, the related information displayed at the second display position is displayed in a superimposed manner on the captured image within the display region 31a (refer to FIG. 5). Here, “displaying the related information in a superimposed manner on the captured image” is displaying the related information such that the related information is viewed in a superimposed on the captured image by replacing a part of the captured image with the related information within the display region 31a.

In the present embodiment, the second display position is set in an inner region 31c (a region hatched in FIGS. 3A and 3B) within the display region 31a. The inner region 31c is a region of which a distance from the end of the display region 31a is greater than or equal to 0.15 and less than or equal to 1.0 in a case where a distance from a center to the end of the display region 31a is 1 in the side-to-side direction (horizontal direction) of the imaging apparatus 10. That is, the second display position is a position at which a distance from the display region 31a is within the range in the side-to-side direction of the imaging apparatus 10. It is preferable that the second display position is a position avoiding the center and a position nearby the center of the display region 31a. In other words, a range in which a distance from the center of the display region 31a is 0.15 to 0.95 may be the inner region 31c.

In addition, a visual field of a person has a conical shape. Thus, in a case where the second display position is set at a position at which the viewing angle of the display device 31 is within 25 degrees, various types of the related information can be displayed within a range in which a movement amount of the visual line of the eyes is small.

Since the second display position is on the inner side of the first display position, the second display position is a position that is viewed by the user looking at the observation unit 30 more easily than the first display position. In addition, in the present embodiment, the second display position is set to the inner region 31c for the purpose of checking the related information displayed at the second display position more easily.

Types of the related information to be displayed at the second display position during imaging are set in advance before imaging. For example, information that is particularly prioritized in information to be checked by the user during imaging corresponds to the related information (hereinafter, referred to as “preset related information”) of the types set in advance before imaging.

In the present embodiment, the preset related information includes the related information selected by the user before imaging. That is, the related information displayed at the second display position can be selected by the user. More specifically, an information selection screen, not illustrated, is displayed on the rear surface display 22 at a point in time at which the user powers ON the imaging apparatus 10 or at a time of an initial start of the imaging apparatus 10. A plurality of displayable types of the related information are presented on the information selection screen as display candidates. The user operates the operating unit 24 by selecting one type or a plurality of types of the related information from the presented related information. For example, the user touches the related information desired to be displayed at the second display position on the touch panel 26.

During imaging, the processor 40 displays the preset related information (in other words, the related information selected by the user before imaging) at the second display position. More specifically, in a case where the user performs a specific operation during imaging (that is, while the live view image as the captured image is displayed on the display device 31), the processor 40 switches between display and non-display of the related information at the second display position.

In addition, in a case where a plurality of pieces of the related information to be di splayed at the second display position are selected, the processor 40 displays the selected plurality of pieces of the related information together on the display device 31 as illustrated in FIG. 5. Accordingly, the user can collectively check the selected plurality of pieces of the related information, and convenience of use for the user is improved.

The preset related information is not limited to a case where the preset related information is set based on a selection of the user. For example, the processor 40 may automatically set the preset related information in accordance with a predetermined selection reference. In addition, a predetermined type of the related information (for example, the related information designated by a maker of the imaging apparatus 10) may be set as default related information to be displayed at the second display position. In this case, the user may appropriately change the related information to be displayed at the second display position through a change screen, not illustrated.

The preset related information may include at least one of the information related to the imaging condition or the information related to the correction condition and may preferably include both of the information. Particularly, it is preferable that the information related to the exposure condition (specifically, the F number, the shutter speed, the ISO sensitivity, and the like) in the information related to the imaging condition is included in the preset related information. This is because the information related to the exposure condition in the imaging condition may particularly affect quality of the captured image and thus, corresponds to one of pieces of information most prioritized by the user.

In the example illustrated in FIG. 5, information i1 to i10 below as the related information related to the imaging condition and i11 to i15 below as the related information related to the correction condition are displayed at the second display position. However, the case illustrated in FIG. 5 is merely an example. Obviously, information other than the information i1 to i15 below may also be displayed at the second display position.

i1: icon representing mode related to flash

i2: icon representing continuous shooting mode

i3: icon representing shutter system

i4: histogram showing distribution of brightness within imaging angle of view

i5: set value of ISO sensitivity

i6: set value of F number

i7: set value of shutter speed

i8: icon representing photometry mode

i9: icon representing imaging mode

i10: indicator showing set value of exposure amount

i11: icon representing ON/OFF of camera shake correction function

i12: icon representing white balance

i13: icon representing color reproduction pattern

i14: icon representing dynamic range

i15: set value of exposure correction

In addition, during imaging, the processor 40 may also display the same related information as the related information (that is, the preset related information) to be displayed at the second display position at the first display position. That is, the preset related information may be displayed at both of the first display position and the second display position on the display device 31 during imaging.

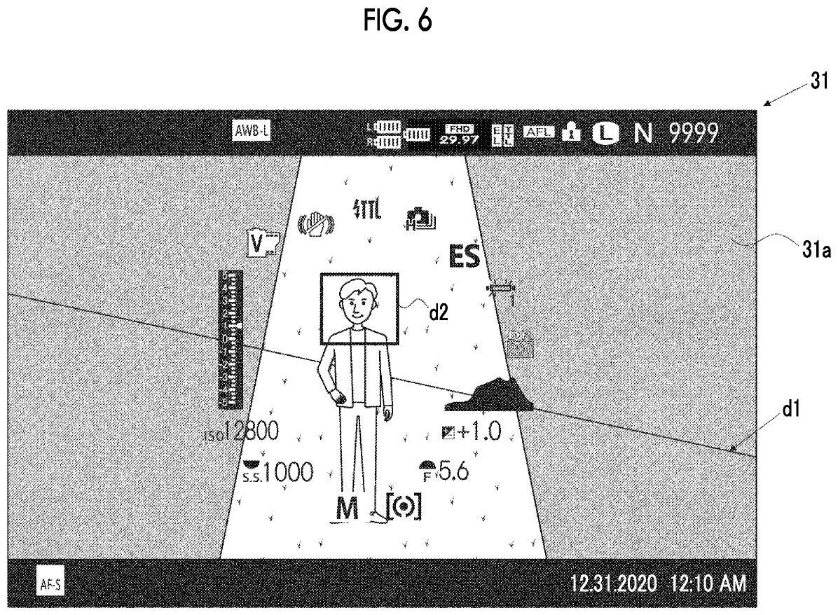

Conversely, while the preset related information is displayed at the second display position, the same related information may not be displayed at the first display position as illustrated in FIG. 6. In addition, in a case where display of the preset related information at the second display position is switched to non-display by deleting the preset related information from the second display position, the related information may be displayed at the first display position. That is, during imaging, the processor 40 may switch a display position of the preset related information from the first display position to the second display position or from the second display position to the first display position based on the specific operation of the user.

In addition, in the present embodiment, a plurality of modes including a first mode and a second mode are prepared as a mode in which the preset related information is displayed at the second display position during imaging. The user provides an instruction for any mode through the operating unit 24. The processor 40 selects one of the two modes in accordance with an instruction input of the user.

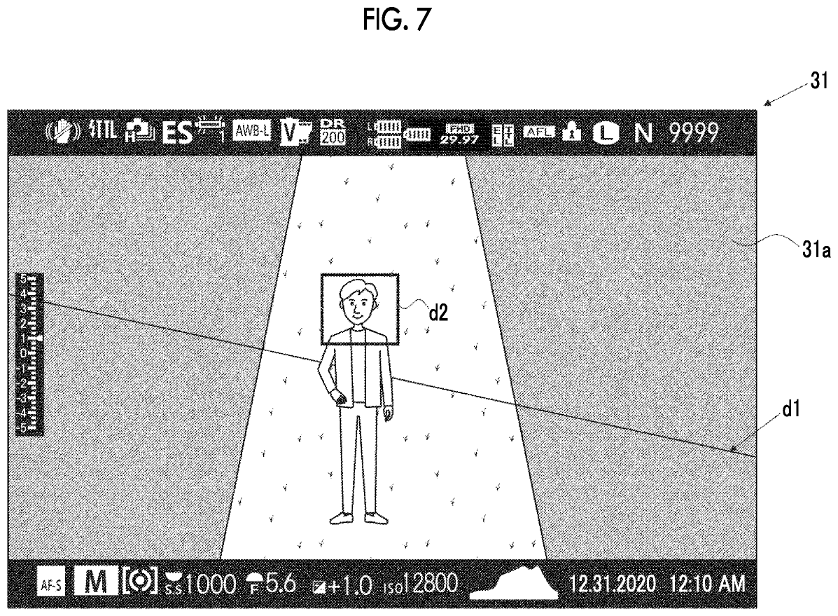

The first mode is a mode in which the preset related information is displayed at the second display position based on a trigger that the specific operation is performed by the user during imaging. That is, in a case where the first mode is selected, the processor 40 displays the related information at only the first display position as illustrated in FIG. 7 before the user performs the specific operation during imaging. In a case where the specific operation is performed during imaging, the processor 40 displays the preset related information at the second display position as illustrated in FIG. 5. At this point, the preset related information displayed at the second display position may be deleted from the first display position as illustrated in FIG. 6. That is, the processor 40 may switch the display position of the preset related information from the first display position to the second display position based on the specific operation performed by the user.

In the first mode, the processor 40 switches display of the related information at the second display position to non-display, after an elapsed time from when the specific operation is performed reaches a setting time (for example, approximately 1 to a few seconds). That is, in the first mode, in a case where a certain time elapses from when the specific operation is performed, the related information displayed at the second display position is deleted from the second display position, and the state illustrated in FIG. 7 is restored. Accordingly, the user can check the related information displayed at the second display position and, after a few seconds, view the captured image (live view image) in a state where the related information is deleted. Consequently, a favorable capturing chance for a subject displayed on the display device 31 is easily provided.

It is preferable that the imaging support mark including the electronic spirit level d1 and the AF frame d2 is displayed in a superimposed manner on the captured image within the display region 31a even after the related information is deleted from the second display position.

The second mode is a mode in which the preset related information is displayed at the second display position in a case where the specific operation is not performed by the user during imaging. That is, in a case where the second mode is selected, the processor 40 displays the preset related information at the second display position during a period in which the specific operation is not performed during imaging. In this case, in a case where a plurality of types of the preset related information are present, the processor 40 displays the plurality of types of the related information at the second display position. In addition, while the specific operation is not performed, the preset related information may be displayed at only the second display position and not displayed at the first display position as illustrated in FIG. 6.

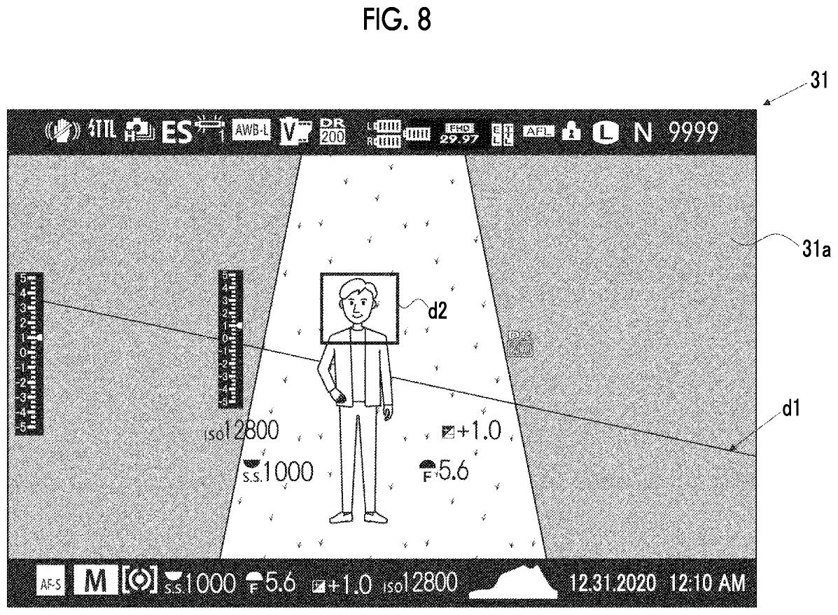

In addition, in the second mode, in a case where the user performs the specific operation during imaging, the processor 40 displays a specific type of the related information at the second display position among the plurality of types of the related information that are the preset related information. That is, in a case where the specific operation is performed during imaging under the second mode, only the specific type of the related information is maintained at the second display position, and the other related information is deleted from the second display position (non-display) as illustrated in FIG. 8. At this point, the related information deleted from the second display position may be displayed at the first display position. That is, the processor 40 may switch the display position of the preset related information from the second display position to the first display position based on the specific operation performed by the user.

The specific type of the related information maintained at the second display position is not particularly limited but preferably includes the information related to the imaging condition and the information related to the correction condition and more suitably includes the information related to the exposure condition. This is because the exposure condition corresponds to a matter most prioritized by the user during imaging as described above.

The specific type of the related information may be designated by the user or may be automatically selected on an imaging apparatus 10 side. In the case illustrated in FIG. 8, the set value i5 of the ISO sensitivity, the set value i6 of the F number, the set value i7 of the shutter speed, the indicator i10 showing the set value of the exposure amount, and the icon i15 of the dynamic range correspond to the specific type of the related information. However, the case illustrated in FIG. 8 is merely an example. Obviously, information other than the above may also be set as the specific type of the related information (that is, the related information maintained at the second display position after the specific operation).

In addition, in the second mode, as in the first mode, the processor 40 switches display of the related information at the second display position to non-display, after the elapsed time from when the specific operation is performed reaches the setting time (for example, approximately 1 second to a few seconds). That is, in the second mode, in a case where a certain time elapses from when the user performs the specific operation during imaging, the related information including the specific type of the related information displayed at the second display position is deleted from the second display position, and the same state as the state illustrated in FIG. 7 occurs. Accordingly, in a case where the user performs the specific operation after checking the related information displayed at the second display position, the user can view the captured image (live view image) in a state where the related information is deleted. Consequently, a favorable imaging chance for the subject displayed on the display device 31 is easily provided.

The imaging support mark including the electronic spirit level d1 and the AF frame d2 is preferably displayed in a superimposed manner on the captured image within the display region 31a even after the related information is deleted from the second display position.

In the present embodiment, an operation of pushing the release button 24a to the position of the first step (half push position) corresponds to the specific operation. That is, in the present embodiment, the display or non-display of the related information at the second display position can be switched in connection with the recording instruction of the captured image. However, the specific operation may be an operation performed through the operating unit 24 (for example, the touch panel 26) other than the release button 24a. Alternatively, the specific operation may be an operation of the user without passing through the operating unit 24. For example, the specific operation may be an operation of bringing the eyes of the user close to within a predetermined distance from the eyepiece window 33 or an operation of separating the eyes of the user from greater than or equal to the predetermined distance from the eyepiece window 33.

In the present embodiment, as described above, since the first mode and the second mode are prepared as the mode in which the related information is displayed at the second display position, the user can select a mode easily used by the user from the first mode and the second mode. Accordingly, the convenience of use for the user is improved. However, the mode in which the related information is displayed at the second display position may be a single mode and may be, for example, only one of the first mode or the second mode (that is, the mode may not be selectable).

For further description of the second display position, in a case where the preset related information corresponds to a plurality of types of the related information, the processor 40 displays the plurality of types of the related information together at a plurality of the second display positions set in the inner region 31c of the display device 31. The plurality of the second display positions are present in the same number as the number of pieces (number of types) of the related information to be displayed.

The plurality of the second display positions may be set such that the plurality of types of the related information are arranged in a circular shape as illustrated in FIG. 5 or arranged in an arc shape. Accordingly, the plurality of types of the related information displayed in the display region 31a can be collectively checked, and checking of the related information is further facilitated. However, the present invention is not limited thereto. The plurality of the second display positions may be decided such that the plurality of types of the related information are arranged in a straight line shape, in a polygonal shape, or irregularly.

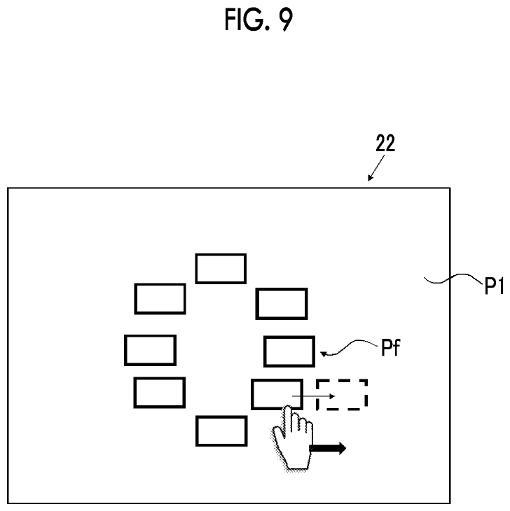

In addition, for example, the processor 40 may change the second display position in accordance with a setting of the user by performing a predetermined change operation on the operating unit 24 by the user. For example, a position setting screen P1 illustrated in FIG. 9 is displayed on the rear surface display 22, and the user moves a variable frame Pf shown on the screen to a desired position by performing a touch-and-drag operation. The processor 40 changes the second display position to a position of the variable frame Pf set by the user.

As described above, by changing the second display position in accordance with the setting of the user by the processor 40, the second display position can be changed to a position at which the related information is more easily viewed by the user. With this effect, the observation unit 30 of the present embodiment can be adapted to users of various ages.

Specifically, the visual field of the user changes in accordance with age, and the visual field tends to be narrowed as the user grows older. Thus, for a user who is old, it is appropriate to set the second display position at a position close to the center of the display region 31a and display the related information at the position. On the other hand, in a case where the second display position is set near the center of the display region 31a, it is difficult to view the captured image (live view image) because of the related information displayed at the position. Thus, for a user who is young and has a wide visual field, it is appropriate to set the second display position at a position slightly separated from a center of the display device 31 and display the related information at the position.

In changing the second display position, it is preferable that a position avoiding the center of the display region 31a (that is, a center part of the captured image) is the second display position. In addition, the second display position may be changeable in a stepwise manner in accordance with the distance (closeness) from the center of the display region 31a. For example, the user may decide the second display position within each of a range close to the center of the display region 31a, a range slightly separated from the center of the display region 31a, and a middle range therebetween.

A method of deciding the second display position by the user is not limited to the above method. For example, a plurality of display position patterns in which the second display position on the display device 31 is defined may be prepared and stored in the internal memory 50 or the like. In this case, the user designates one of the plurality of display position patterns before imaging, and the processor 40 decides the second display position in accordance with the pattern designated by the user.

In addition, the processor 40 may identify the user, and the processor 40 may select one pattern corresponding to the identified user from the plurality of display position patterns. A correspondence relationship between the user and the display position pattern may be stored in the internal memory 50 or the like as table data. In addition, well-known user authentication means can be used as means for identifying the user. Examples of the user authentication means include well-known fingerprint authentication means, iris authentication means, face authentication means, and voiceprint authentication means. Alternatively, the user may perform an input operation for user authentication, and the processor 40 may identify the user based on the input operation.

Furthermore, in a case where the second changes the second display position, it is preferable that the changed second display position is stored in the internal memory 50 or the like in association with the user. In next and subsequent imaging, the processor 40 may read out the second display position corresponding to the identified user from the internal memory 50 or the like and display the preset related information at the read-out second display position. Accordingly, a setting of the second display position does not need to be set for each imaging, and this can reduce an effort of the user.

Specifications in which the second display position is set on the imaging apparatus 10 side and the set second display position cannot be arbitrarily changed by the user are also possible.

In addition, the second display position may be appropriately changed in accordance with a color or a design of each region of the captured image during imaging. In other words, the processor 40 may change the second display position in accordance with the color or the design of each region of the captured image. Each region of the captured image is each image region in a case where the captured image is compartmentalized in accordance with a predetermined rule. The color of each region is hue, chroma saturation, and lightness (brightness) of each region. The design of each region geometrically (specifically, such that a regular or irregular shape is formed) represents color and shape patterns in each region and includes, for example, a texture, a style, a drawing style, and color arrangement pattern.

In changing the second display position in accordance with the color or the design (hereinafter, the color or the like) of each region of the captured image, a correspondence relationship between a display color of the related information and the color or the like of the image in which the display color and the color or the like make it difficult to view each other (hereinafter, a correspondence relationship of the color or the like causing difficulty in viewing) is specified using machine learning.

For example, the machine learning may be performed on a maker side of the imaging apparatus 10 before shipment of the imaging apparatus 10. In the machine learning, data related to difficulty in viewing text information of each color in a case where the text information of each color is displayed in a superimposed manner on each of a plurality of the sample images having different colors or the like may be used as training data. In addition, the imaging apparatus 10 may be subjected to the machine learning after the shipment of the imaging apparatus 10. In this case, data related to difficulty in viewing the related information in a case where the related information is displayed in a superimposed manner on the actual captured image may be used as the training data. A method, an algorithm, and the like of the machine learning are not particularly limited, and well-known methods, algorithms, and the like can be used.

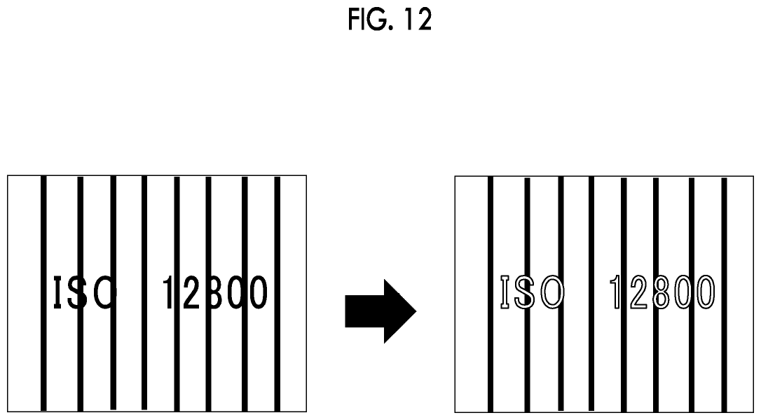

A result of the machine learning, that is, the correspondence relationship of the color or the like causing difficulty in viewing, is stored in the internal memory 50 or the like of the imaging apparatus 10. In displaying the related information at the second display position during imaging, the processor 40 refers to the correspondence relationship of the color or the like causing difficulty in viewing and determines whether or not the color or the like of a region including the second display position is a color or the like that makes it difficult to view the related information in the captured image. For example, in a case where a contrast (difference) between a color of the region and the display color of the related information is below a reference value, the color of the region corresponds to the color or the like that makes it difficult to view the related information. In addition, in a case where a shape of a design of the region interferes with the related information, for example, in a case where a boundary line or the like of the design is viewed as being falsely recognized as a part of the related information, the design of the region corresponds to the color or the like that makes it difficult to view the related information (refer to the left diagram in FIG. 12).

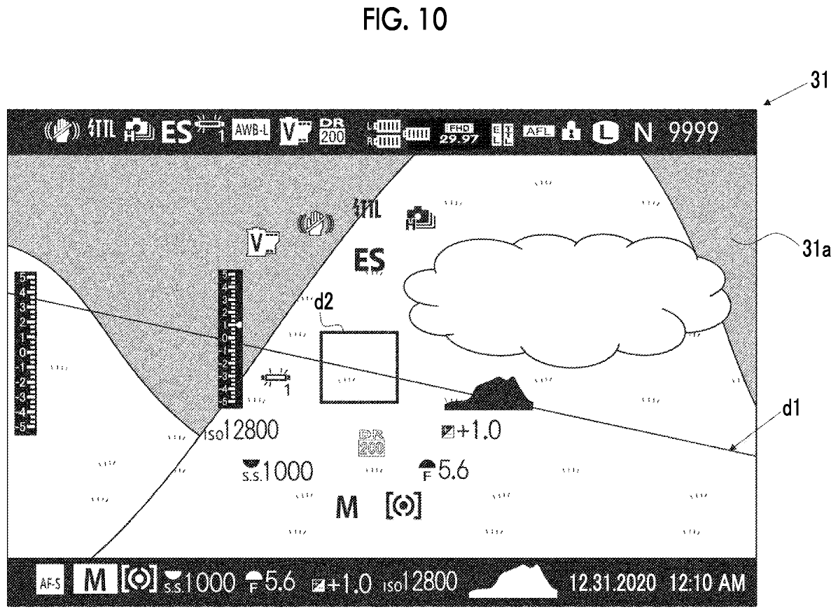

In a case where the color or the like of the region including the second display position in the captured image is the color or the like that makes it difficult to view the related information, the processor 40 changes the second display position to a position separated from the region. Specifically, as illustrated in FIG. 10, the processor 40 specifies a region having a color or the like that makes it easy to view the display color of the related information, and sets the second display position in the specified region. In the case illustrated in FIG. 10, the related information displayed in white is displayed at a display position separated from a white region (specifically, a region in which a white cloud is captured) in the captured image.

As described above, the second display position can be decided at an appropriate position based on the correspondence relationship of the color or the like causing difficulty in viewing. Consequently, the related information to be displayed at the second display position during imaging (that is, during display of the captured image) is more easily viewed by the user.

In addition, the second display position may be appropriately changed during imaging in accordance with the distance from the user to the observation unit 30. In other words, the processor 40 may change the second display position during imaging based on the signal output from the measurement sensor 34.

Specifically, for example, the distance from the user to the observation unit 30 in a case where the user looks at the observation unit 30, more specifically, a distance from the eyes of the user to the eyepiece window 33, changes depending on whether or not the user wears glasses. In a case of a user not wearing glasses, the widest viewing angle (visual field) in a case where the user looks at the observation unit 30 is achieved by aligning the eyes of the user with the eyepoint of the observation unit 30. On the other hand, in a case of a user wearing glasses, the eyes of the user cannot be aligned with the eyepoint of the observation unit 30. Thus, the viewing angle in a case where the user looks at the observation unit 30 is narrower than for the user not wearing glasses.

Considering the above points, a pattern in a case where the user wears glasses and a pattern in a case where the user does not wear glasses are prepared as a pattern for deciding the second display position. In this case, the second display position in a case where the user wears glasses may be present on an inner side of the display device 31 than the second display position in a case where the user does not wear glasses.

The processor 40 calculates the distance from the user to the observation unit 30 based on the output signal from the sensor 34 and determines whether or not the user wears glasses from the distance. Then, the processor 40 selects one of the two patterns in accordance with a determination result as to whether or not the user wears glasses and sets the second display position in accordance with the selected pattern. According to the above, the second display position can be decided at an appropriate position depending on whether or not the user wears glasses. Consequently, the related information to be displayed at the second display position during imaging is more easily viewed for each of the user wearing glasses and the user not wearing glasses.

It is preferable that the user can arbitrarily set and change (that is, customize) the second display position in each of a case of wearing glasses and a case of not wearing glasses.

In addition, a method of determining whether or not the user wears glasses is not limited to a method of determination based on the output signal from the sensor 34, that is, a method of determination based on the distance from the user to the observation unit 30. Other methods may also be used. For example, whether or not the user wears glasses may be determined by acquiring a face image of the user before imaging or during imaging and analyzing the face image. Alternatively, the user may perform an input operation of selecting whether or not glasses are worn, and the processor 40 may determine whether or not glasses are worn based on the input operation.

As described so far, the second display position may be appropriately changeable in accordance with a situation during imaging. In addition, a display aspect of the related information to be displayed at the second display position (hereinafter, simply referred to as the “display aspect of the related information”) may be appropriately changeable instead of changing the second display position or together with the second display position. For example, the display color, a display format such as a font, and a display size of the related information correspond to the display aspect of the related information.

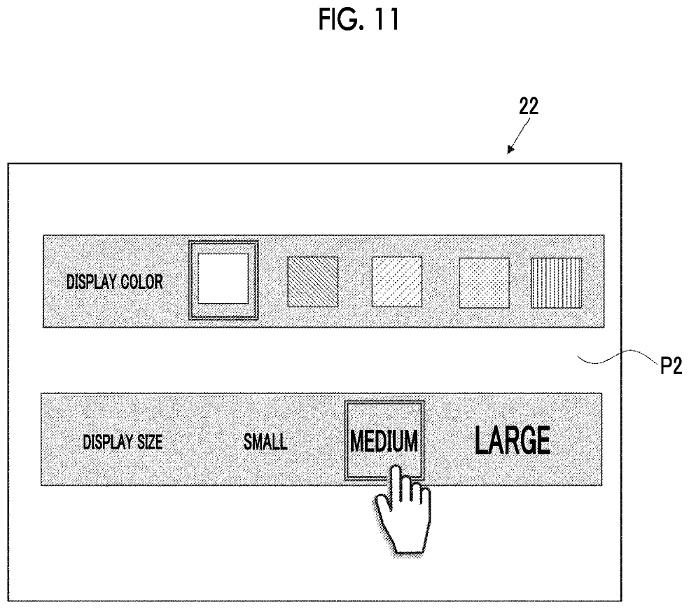

The display aspect of the related information may be changeable by operating the operating unit 24 by the user. In other words, the processor 40 may change the display aspect of the related information in accordance with the setting of the user. For example, a display aspect setting screen P2 illustrated in FIG. 11 is displayed on the rear surface display 22 before imaging, and the user selects and touches a preference on the screen from each candidate of the display color and the display size displayed on the display aspect setting screen P2. The processor 40 sets the display color and the display size selected by the user as the display aspect of the related information.

As described above, by changing the display aspect of the related information in accordance with the setting of the user by the processor 40, the convenience of use for the user is improved. For example, in a case of a user who is old, the related information to be displayed at the second display position can be still more easily viewed by increasing the display size of the related information. On the other hand, in a case of a user who is young, the user can even recognize information of a relatively small size. Thus, both of the captured image and the related information can be efficiently checked by decreasing the display size of the related information.

It is preferable that the display aspect of the related information changed in accordance with the setting of the user is stored in the internal memory 50 or the like. In next and subsequent imaging, the processor 40 may read out the display aspect from the internal memory 50 or the like and display the related information at the second display position in the read-out display aspect. Accordingly, the display aspect of the related information does not need to be set for each imaging, and this can reduce the effort of the user.

Specifications in which the display aspect of the related information is set on the imaging apparatus 10 side and the set display aspect cannot be arbitrarily changed by the user are also possible.

In addition, the display aspect of the related information may be appropriately changed during imaging in accordance with the color or the like (the color or the design) of each region of the captured image. In other words, the processor 40 may change the display aspect of the related information in accordance with the color or the like of each region of the captured image. Specifically, the processor 40 specifies the correspondence relationship of the color or the like causing difficulty in viewing in advance by performing the machine learning. The processor 40 specifies the display aspect that is easily identified in a relationship with the color or the like of the region during imaging based on the color or the like of the region including the second display position in the captured image and the correspondence relationship of the color or the like causing difficulty in viewing. For example, as illustrated in FIG. 12, in a case where it is difficult to view the related information because of color arrangement, a pattern, and the like of the design, the display color of the related information may be changed so that the related information is easily viewed. The left diagram in FIG. 12 is a diagram before the display color of the related information is changed, and the right diagram in FIG. 12 is a diagram after the display color of the related information is changed.

As described above, it is preferable that the related information is displayed at the second display position in an appropriate display aspect, that is, in a display aspect easily identified in a relationship with the surrounding color or the like. Accordingly, the related information to be displayed at the second display position is still more easily viewed by the user.

In addition, the display aspect of the related information may be appropriately changed during imaging in accordance with the distance from the user to the observation unit 30. In other words, the processor 40 may change the display aspect of the related information during imaging based on the signal output from the measurement sensor 34. Specifically, a pattern in a case where the user wears glasses and a pattern in a case where the user does not wear glasses are prepared as a pattern for deciding the display aspect (specifically, the display color, the display size, and the like) of the related information. In this case, the display size in a case where the user wears glasses may be smaller than the display size in a case where the user does not wear glasses, considering that the viewing angle (visual field) is narrowed.

During imaging, the processor 40 determines whether or not the user wears glasses based on the output signal from the sensor 34, selects one of the two patterns in accordance with the determination result, and decides the display aspect of the related information in accordance with the selected pattern. According to the above, the display aspect of the related information can be appropriately switched depending on whether or not the user wears glasses. Consequently, the related information to be displayed at the second display position during imaging is still more easily viewed for each of the user wearing glasses and the user not wearing glasses.

The user may arbitrarily set and change (that is, customize) the display aspect of the related information in each of a case of wearing glasses and a case of not wearing glasses.

[Operation Example of Imaging Apparatus According to Present Embodiment]

As an operation example of the imaging apparatus 10, a flow of processing (hereinafter, referred to as display processing) of displaying the captured image and the related information on the display device 31 of the observation unit 30 will be described.

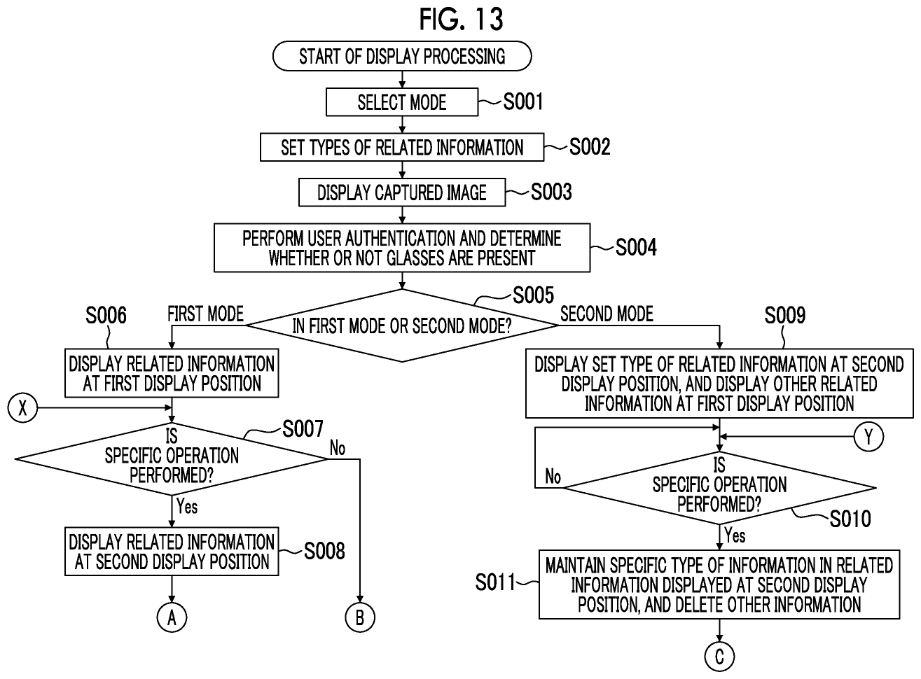

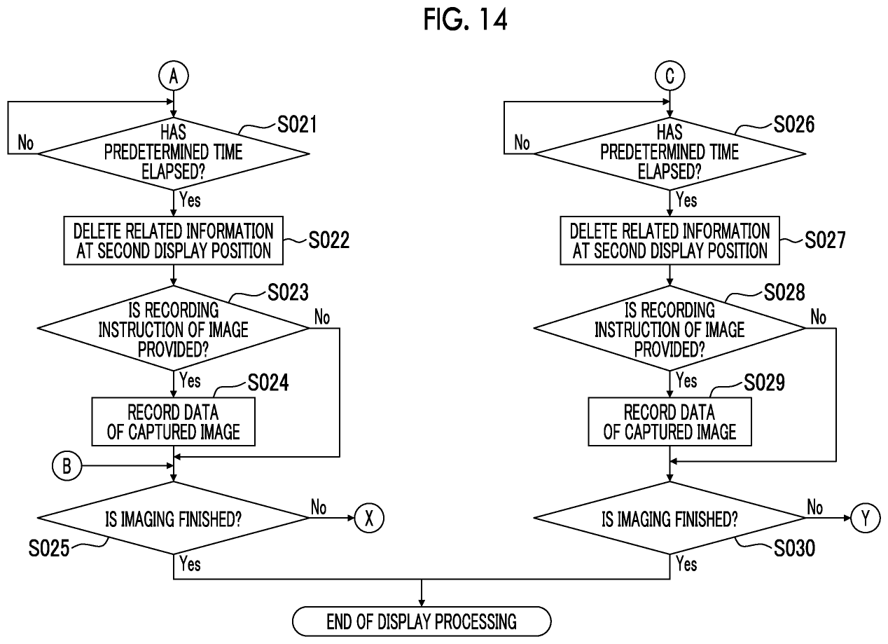

The display processing proceeds in accordance with the flows illustrated in FIGS. 13 and 14. In the display processing, first, the user selects any of the first mode and the second mode (S001). In addition, the user sets the type of the related information to be displayed at the second display position, that is, the preset related information, before imaging (S002). The preset related information may be set by default. In this case, the step of S002 may be omitted.

Then, imaging is started, and in a case where the user looks at inside the observation unit 30 and the distance from the user to the observation unit 30 is less than or equal to the predetermined distance, the processor 40 displays the live view image in the display region 31a of the display device 31 as the captured image (S003). At this point, the imaging support mark such as the electronic spirit level d1 and the AF frame d2 is displayed in the display region 31a together with the captured image.

In addition, in imaging, the processor 40 may perform user authentication by detecting an iris or the like of the user. In addition, the processor 40 may determine whether or not the user is wearing glasses based on the distance from the user to the observation unit 30 (S004).

In a case where the user selects the first mode in S001, the processor 40 displays the related information at the first display position until the user performs an operation of pushing the release button 24a to the position of the first step (half push position) as the specific operation (S005 and S006).

In a case where the specific operation is performed, the processor 40 displays the preset related information set in S002 at the second display position within the display region 31a of the display device 31 (S007 and S008). At this point, the second display position may be a default position set in advance or may be a position decided in accordance with the user authenticated in S004. In addition, the processor 40 may change the display aspect (specifically, the display color and the display size) of the preset related information in accordance with the setting of the user.

In addition, the processor 40 may change the second display position and the display aspect of the related information to be displayed at the second display position depending on whether or not the user wears glasses. In addition, the processor 40 may change the second display position and the display aspect of the related information to be displayed at the second display position based on a relationship between the color or the like of each region in the captured image and the display color of the related information to be displayed at the second display position.

In addition, the same information as the preset related information in the related information displayed at the first display position may be deleted from the first display position after the information is displayed at the second display position by performing the specific operation.

In a case where the elapsed time from when the specific operation is performed reaches the predetermined time, the processor 40 switches display of the preset related information at the second display position to non-display (S021 and S022). The related information deleted from the first display position by displaying the related information at the second display position may be displayed again at the first display position after S022. Even after S022, the imaging support mark such as the electronic spirit level d1 and the AF frame d2 is continuously displayed in the display region 31a together with the captured image.

Then, in a case where the user provides the recording instruction of the image by pushing the release button 24a to the position of the second step (full push position) (S023), the processor 40 records the data (image data) of the captured image at the point in time in the internal memory 50, the memory card 52, or the like (S024). At this point, the processor 40 adds data of the related information displayed at the second display position, that is, data of the preset related information, to the image data and records the image data to which the data is added.

Then, in a case where the user performs an operation for finishing imaging, the processor 40 finishes imaging and the display of the captured image (S025). At this point in time, the display processing is finished.

Returning to S005, in a case where the user selects the second mode, the processor 40 displays the preset related information set in S002 at the second display position while the specific operation is not performed (S009). At this point, the second display position may be the default position or may be a position decided in accordance with the user authenticated in S004. In addition, the processor 40 may change the second display position and the display aspect of the related information depending on the setting of the user or whether or not the user wears glasses. In addition, the processor 40 may change the second display position and the display aspect of the related information in accordance with the color or the like of each region in the captured image.

Then, in a case where the user pushes the release button 24a to the position of the first step, the processor 40 maintains the specific type of the related information in the related information displayed at the second display position and deletes the other related information from the second display position (S011). The specific type of the related information may be decided on the imaging apparatus 10 side or may be selected in advance by the user. In addition, the related information deleted from the second display position in S011 may be displayed at the first display position after S011.

In a case where the elapsed time from when the specific operation is performed reaches the predetermined time, the processor 40 deletes the specific type of the related information maintained at the second display position from the second display position (S026 and S027). The specific type of the related information deleted from the second display position may be displayed again at the first display position after S027. In addition, even after S027, the imaging support mark such as the electronic spirit level d1 and the AF frame d2 is continuously displayed in the display region 31a together with the captured image.

Subsequent steps S028 to S030 are the same as in a case of the first mode (that is, S023 to S025).

[Effectiveness of Present Embodiment]

In a display device of a general observation unit (specifically, an EVF) in the related art, the related information is mostly displayed in an outer edge portion of the display device. Thus, it may be difficult to view the related information. On the other hand, in a case where the display position of the related information is moved to the inner side of the display device 31 as a whole, a region overlapping with the related information is increased in the captured image (live view image). Thus, it is difficult to view the captured image.

On the other hand, in the imaging apparatus 10 of the present embodiment, during imaging, the processor 40 displays the related information at the second display position present on the inner side of the display device 31 than the first display position. In addition, the types of the related information to be displayed at the second display position are set in advance before imaging. That is, in the present embodiment, types of the related information important for the user are set in advance before imaging, and the related information is displayed at the second display position easily viewed on the display device 31 during imaging. Accordingly, checking the important related information together with the captured image (live view image) during imaging is facilitated.

The above effect is particularly meaningful in a case where a size of the display device 31 is increased, for example, in a case where the viewing angle of the display device 31 in the side-to-side direction of the imaging apparatus 10 is greater than or equal to 33 degrees. As the size of the display device 31 is increased, the sense of immersion in the captured image (live view image) displayed on the display device 31 is improved. However, it is still more difficult to view information displayed in an outer edge portion of the display device 31. With respect to such a situation, according to the imaging apparatus 10 of the present embodiment, more important related information can be displayed at the second display position. Thus, the related information can be easily checked.

In addition, in the present embodiment, display or non-display of the related information at the second display position can be performed at an appropriate timing in accordance with the specific operation of the user. Accordingly, the user can check more important related information at an appropriate timing (for example, immediately before providing the recording instruction of the captured image).

In the imaging apparatus disclosed in WO2010/029767A and JP2018-125801A, during imaging, the imaging condition is displayed in the outer edge portion of the display device in the finder. In a case where the user performs a condition change operation, a condition related to the operation is displayed on the inner side of the display device. However, in the imaging apparatus disclosed in WO2010/029767A and JP2018-125801A, information (imaging condition) displayed on the inner side of the display device is limited to the condition related to the change operation of the user.

On the other hand, in the imaging apparatus 10 of the present embodiment, the user sets types of the related information in advance before imaging, the related information is displayed on the inner side of the display device, and furthermore, display and non-display of the related information is switched in accordance with the operation of the user. In such a point, the imaging apparatus 10 of the present embodiment provides higher convenience of use than the imaging apparatus disclosed in WO2010/029767A and JP2018-125801A.

[Other Embodiments]

The embodiment described so far is an example for describing the configuration of the imaging apparatus according to the embodiment of the present invention in an understandable manner but is merely an example. Other embodiments may also be considered.

In the embodiment, while a digital camera with an EVF is illustrated as an example of the imaging apparatus according to the embodiment of the present invention, the present invention is not limited thereto. The present invention can also be applied to other imaging apparatuses (for example, a video camera and a smartphone) with an EVF.

In addition, in the embodiment, while the processor 40 is incorporated in a body of the imaging apparatus 10, the present invention is not limited thereto. For example, a camera controller connected to the imaging apparatus 10 in a wired or wireless manner may constitute a processor according to the embodiment of the present invention. In this case, the camera controller functions as the control processing unit 42 and the image generation unit 44 in cooperation with the processor (specifically, a control circuit or the like inside the camera) inside the body of the imaging apparatus.

In addition, while the observation unit 30 is a finder incorporated in the imaging apparatus 10 or a finder of an external type connected to the connecting unit 14 such as a hot shoe, the present invention is not limited thereto. For example, the observation unit 30 may be a finder of a head mounted display (HIVID) type that is separated from the body of the imaging apparatus 10 and is wearable by the user or a finder of a glasses type such as augmented reality (AR) glasses. In this case, the processor 40 communicates with the finder of the HMD type or the glasses type and remotely controls a display device provided in the finder.

### EXPLANATION OF REFERENCES

10: imaging apparatus

12: imaging lens

12a: zoom lens

12b: focus lens

14: connecting unit

16: stop

18: shutter

20: imaging element

22: rear surface display

24: operating unit

24a: release button

26: touch panel

30: observation unit

31: display device

31a: display region

31b: outer edge region

31c: inner region

32: observation optical system

33: eyepiece window

34: sensor

40: processor

42: control processing unit

44: image generation unit

46a, 46b: lens drive unit

50: internal memory

52: memory card

80: measurement camera

82: imaging element

P1: position setting screen

Pf: variable frame

P2: display aspect setting screen

What is claimed is:

1. An imaging apparatus comprising:
an imaging element;
an observation unit including a display device and an observation optical system; and
a processor configured to display a captured image based on an imaging signal read out from the imaging element and related information related to generation of the captured image, on the display device,
wherein the processor is configured to display the related information at a first display position and a second display position on the display device during imaging performed by the imaging element,
the second display position is present on an inner side of the display device than the first display position,
types of the related information to be displayed at the second display position are set in advance before imaging, and
the processor is configured to switch between display and non-display of the related information at the second display position based on a specific operation of a user during imaging.

2. The imaging apparatus according to claim 1,
wherein the second display position is a position overlapping with the captured image.

3. The imaging apparatus according to claim 1,
wherein a horizontal viewing angle of the display device in a longitudinal direction of the imaging element is greater than or equal to 33 degrees.

4. The imaging apparatus according to claim 1,
wherein the related information to be displayed at the second display position is selectable by the user, and
the processor is configured to, in a case where a plurality of pieces of the related information to be displayed at the second display position are selected, display the selected plurality of pieces of the related information together on the display device.

5. The imaging apparatus according to claim 1,
wherein the related information to be displayed at the second display position includes at least one of information related to an imaging condition of the imaging element or information related to a correction condition of the imaging signal.

6. The imaging apparatus according to claim 1,
wherein the related information to be displayed at the second display position includes at least one of a shutter speed, sensitivity of the imaging element, or an F number of an imaging lens at a time of capturing.

7. The imaging apparatus according to claim 1,
wherein the processor is configured to change at least one of the second display position or a display aspect of the related information to be displayed at the second display position in accordance with a setting of the user.

8. The imaging apparatus according to claim 1,
wherein the processor is configured to change at least one of the second display position or a display aspect of the related information to be displayed at the second display position in accordance with a color or a design of each region of the captured image.

9. The imaging apparatus according to claim 1,
wherein the processor is configured to, in a case where the specific operation is performed or in a case where the specific operation is not performed during imaging, display the related information at the second display position.

10. The imaging apparatus according to claim 1,
wherein the processor is configured to, in a case where the specific operation is performed during imaging, switch display of the related information at the second display position to non-display, after an elapsed time from when the specific operation is performed reaches a setting time.

11. The imaging apparatus according to claim 9, further comprising:
a release button pushed by the user,
wherein the release button is pushable in two steps by the user, and
the specific operation is an operation of pushing the release button to a position of a first step.

12. The imaging apparatus according to claim 1,
wherein a mode in which the related information is displayed at the second display position includes
a first mode in which the related information is displayed at the second display position in a case where the specific operation is performed during imaging, and
a second mode in which the related information is displayed at the second display position in a case where the specific operation is not performed during imaging, and
the processor is configured to select one of the first mode and the second mode based on an instruction input of the user.

13. The imaging apparatus according to claim 1, further comprising:
a sensor that outputs a signal corresponding to a distance from the user to the observation unit,
wherein the processor is configured to change at least one of the second display position or a display aspect of the related information to be displayed at the second display position based on the signal output from the sensor.

14. The imaging apparatus according to claim 1,
wherein the display device has a display region in which an image is displayed, and
in a case where a distance from a center of the display region to an end of the display region in a longitudinal direction of the imaging element is 1, the second display position is a position at which a distance from the end of the display region is greater than or equal to 0.15 and less than or equal to 1.0.

15. The imaging apparatus according to claim 1,
wherein the second display position is a position at which a viewing angle of the display device is within 25 degrees.

16. The imaging apparatus according to claim 1,
wherein the processor is configured to switch a display position of the related information from one of the first display position and the second display position to the other based on the specific operation.

17. The imaging apparatus according to claim 1,
wherein the processor is configured to record data of the captured image to which data of the related information is added on a recording medium based on a recording instruction of the captured image provided by the user.

18. A program used in an imaging apparatus including an imaging element and an observation unit including a display device and an observation optical system,
wherein a captured image based on an imaging signal read out from the imaging element and related information related to generation of the captured image are displayed on the display device,
the related information is displayed at a first display position and a second display position on the display device during imaging performed by the imaging element,
the second display position is present on an inner side of the display device than the first display position,
types of the related information to be displayed at the second display position are set in advance before imaging, and
display or non-display of the related information at the second display position is switched based on a specific operation of a user during imaging.

19. The imaging apparatus according to claim 2,
wherein a horizontal viewing angle of the display device in a longitudinal direction of the imaging element is greater than or equal to 33 degrees.

20. The imaging apparatus according to claim 2,
wherein the related information to be displayed at the second display position is selectable by the user, and
the processor is configured to, in a case where a plurality of pieces of the related information to be displayed at the second display position are selected, display the selected plurality of pieces of the related information together on the display device.
